(19) United States
(12) Patent Application Publication
(10) Pub. No.: US 2021/0128958 A1
(43) Pub. Date: May 6, 2021

(54) FIRE SUPPRESSING GAS-GENERATING DEVICE

(71) Applicant: SIA N2 GLOBAL, Riga (LV)

(72) Inventor: Normunds NEBOJS, Tallinn (EE)

(21) Appl. No.: 16/639,573

(22) PCT Filed: Aug. 16, 2017
(86) PCT No.: PCT/IB2017/054984

§ 371 Date: Feb. 16, 2020

(51) Int. Cl. A62C 5/00; A62D 1/06

(52) U.S. Cl. CPC A62C 5/006; A62D 1/06

(57) ABSTRACT

Invention relates to a fire suppressing gas generating device. The device comprises a housing with an array of discharge openings. The device further comprises a plurality of gas-generating grains disposed within the housing; a multi-layer filter; an ignition device associated with the gas generating grains for ignition of said the gas-generating grains; and a foil section disposed over said discharge openings.

### FIELD OF THE INVENTION

Invention relates to fire suppressing or extinguishing devices, especially to the fire suppressing gas-generating devices.

### BACKGROUND OF THE INVENTION

Fire suppressing gas-generating devices are used to suppress fires in enclosed volumes, such as automobiles, planes, ships, server rooms, buildings, etc. Vehicles are subjected to vibrations, which puts higher demands for stability and long term use or shelf life for gas-generating devices. Therefore, it is necessary to design a fire suppressing gas-generating device, which can withstand vibrations without losing its performance.

U.S. Pat. No. 7,832,493 discloses a fire suppression device including a fire suppression agent generator. The device comprises a trigger adapted to initiate generation of the fire suppression agent from the fire suppression agent generator. A container at least partially surrounds the fire suppression agent generator and the trigger, the container includes a discharge port that directs fire suppression agent in at least two opposed directions. In one example, the discharge port extends substantially around a perimeter of the container.

International patent application publication No. WO 2011/041879 discloses a fire suppressing gas generator, that comprises a cylindrical housing comprising an array of discharge ports distributed generally uniformly therearound; a cylindrical filter disposed within the housing and spaced from the interior wall of the housing; a plurality of azide-based propellant grains inside the cylindrical filter; and at least one ignition device associated with the propellant grains. The propellant grains when ignited by the ignition device generate a fire suppressing gas which passes through the filter and out of the discharge ports of the cylindrical housing for delivery outside from the housing into environment to be suppressed.

United States patent application publication No. 2010/0307775 discloses a gas generating device with grain-retention structures. In particular, the gas generating device has at least one retention structure fixed to a frame and positioned between adjacent gas generating grains arranged in a longitudinal stack. Said device has plurality of elements, which makes manufacturing process complicated, especially in assembling.

Moreover, above-mentioned devices does not provide effective means nor for withstanding environment vibrations nor for improving easiness of assembling.

The aim of invention is to design a gas generating device, which is reliable in long term and easy to manufacture, especially to assemble.

Present invention is a fire suppressing gas-generating device comprising a housing, a plurality of gas-generating grains, a multi-layer filter, a sealing ring and a foil section.

The housing comprises a base shell and a cover shell. Each shell is made in a shape of a plate (plate-like) having base portion and a flange positioned there around. Therefore, the hosing consists of two housing shells. Both shells form a base and a cover. Both shells are connected to each other through flanges. In another embodiment, the device may comprise a spacer and then the flanges of both shells are connected to flanges of the spacer. Both shells and the spacer of the housing are connected to each other by means of laser welding and the welding seam is annular welding seam between the flanges of the both shells of the housing or in another embodiment between the flanges of both shells and the flanges of the spacer. Moreover, the flanges function not only as connecting elements but the flanges may be used for various attachment elements which are used for attachment of the device to other constructions or structures.

The aim of the spacer is to increase the inner volume of the housing in order to dispose more gas-generating grains within the housing increasing a power of fire suppressing of the fire suppressing gas-generating device. Accordingly, in the embodiment without the space the gas-generating grains are disposed in one plane and preferably on an inner surface of a base portion of the base shell. In embodiment with the spacer, the gas-generating grains a arranged in multiple columns.

Moreover, the cover shell comprises an array of discharge openings distributed generally over the base portion of the cover shell. A foil section or a burst foil is attached to the base portion of the cover shell covering the discharge openings. The foil section is adhesively attached to an inner surface or to an outer surface of the base portion of the cover shell covering the discharge openings. The foil section may be in one piece that covers all discharge opening at once, but in another embodiment the foil section may be dimensioned so that it covers only one discharge opening. Hence, for each discharge opening a separate foil section is provided. The discharge opening may be in various shapes, generally round star shaped. The sharp edges of the star shaped opening will ease breakage of the foil upon burst of gas generating grains. The foil section is selected from the group of the following metals: steel, stainless steel, aluminium, copper and tin. The foil is selectively disposed only on discharge opening to cover and protect the interior of the housing from the environment. The foil section may be attached to the inner surface of the base portion of the cover shell or the outer surface of the base portion of the cover shell. The foil is attached to the outer surface of the base portion of the cover shell or the housing by means of adhesive in such way that upon exposure to heat, which is generated from ignition of the gas generating grains, the adhesive weakens to allow separation of the foil from the housing to allow an outflow of generated gas through the discharge opening.

A plurality of gas generating grains are disposed within the housing. The shape and amount of gas generating grains depend on performance requirements for the fire suppressing gas-generating device. The housing, filter and discharge opening size and shape can be adapted to the necessary requirements. The gas-generating grains may be disposed within the base shell of the housing or within the spacer. A composition of gas-generating grain comprises a guanidine nitrate, basic copper nitrate and an additive. The gas generating grain can further comprise a fuel for enhancing ignition process.

The device comprises a multi-layer filter disposed between the gas generating grains and the base portion of the cover shell of the housing in order to filter generated gases. In another embodiment, the multi-layer device may be disposed in a base shell having discharge opening when the spacer is implemented. The multi-layer filter comprises at least one layer of steel mesh, at least one layer of steel wool and at least one layer of Si02 felt. The multi-layer filter is shaped in a form of a disc.

The device comprises a sealing ring disposed around the multi-layer filter so that the sealing ring is between the inner surface of the cover shell and the multi-layer filter.

The device further comprises an ignition device associated with the gas generating grains for ignition of said the gas-generating grains. The ignition device is associated with the gas-generating grains for ignition of said the gas-generating grains. The ignition device further comprises a fire guide to increase ignition. The igniting device may further comprise ignition enhancing elements for sustaining ignition and following burn of the gas generating grains. Moreover, the ignition device comprises an ignition exhaust channel that extends towards the gas-generating grains to facilitate a reach of a flame from an ignitor disposed within the ignition device.

The fire suppressing gas-generating device further comprises a positioning ring arranged around the gas-generating grains and between an inner surface of the base shell and the gas-generating grains for restricting a movement of the gas-generating grains in the housing.

The following design is very compact comparing to the prior-art fire suppressing gas-generating devices. The invented device can be mounted in a ceiling of building, easily positioned within an engine compartment of a vehicle or positioned in date centre in proximity of servers. The proposed shape and arrangement of gas-generating grains, filter and gas discharge openings allows installation of said device in restricted place or space without compromising the fire supressing capabilities or performance.

### BRIEF DESCRIPTION OF THE DRAWINGS

The drawings illustrate generally, by way of example, but not by way of limitation, various embodiments of the invention.

FIG. 1 is a perspective view of one embodiment of a fire suppressing gas-generating device.

FIG. 2 is a cross-sectional view of a fire suppressing gas-generating device showed in FIG. 1.

FIG. 3 illustrates a fire suppressing gas-generating device when a cover shell 111 is removed including a multi-layer filter 5 and a foil section 7 displaying gas generating grains 4 and an ignition device 6.

FIG. 4 is a cross-sectional view of a fire supressing gas-generating device showed in FIG. 3 that illustrates an ignition device 6 having an exhaust channel 6A directed to the gas generating grains 4.

FIG. 5 is a cross-sectional view of an ignition device 6 comprising an ignitor 6B and an exhaust channel 6A.

FIG. 6 is a perspective view of another embodiment of a fire suppressing gas-generating device that further comprises a positioning ring 8. FIG. 6 illustrates partly assembled fire suppressing gas-generating device.

FIG. 7 is a perspective view of another embodiment of a fire suppressing gas-generating device further comprising a spacer 3.

FIG. 8 is a cross-sectional view of a fire suppressing gas-generating device showed in FIG. 8.

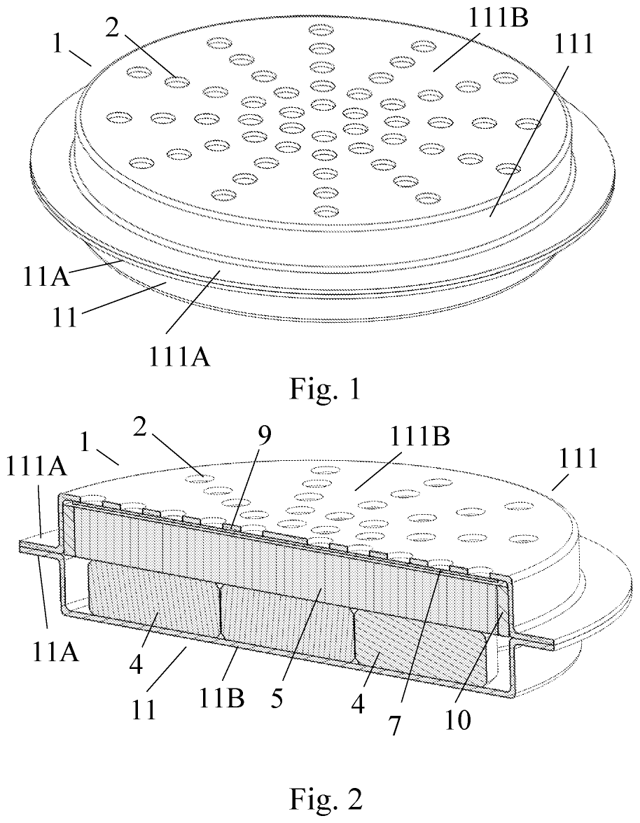

A fire suppressing gas generating device according to one embodiment shown in FIGS. 1 and 2 comprises a housing 1. The housing 1 comprises a plate-like base shell 11 and a plate-like cover shell 111, wherein each shell 11 and 111 comprises a respective flange 11A and 111A and a respective base portion 11B and 111B. The shells 11 and 111 are connected to each other through flanges of both shells. Moreover, the cover shell 111 comprises an array of discharge openings 2 distributed generally over the base portion 111B of the cover shell 111. Both shells 11 and 111 of the housing 1 are connected by means of laser welding and the welding seam is annular welding seam between the flanges 11A and 111A of both shells 11 and 111 of the housing 1.

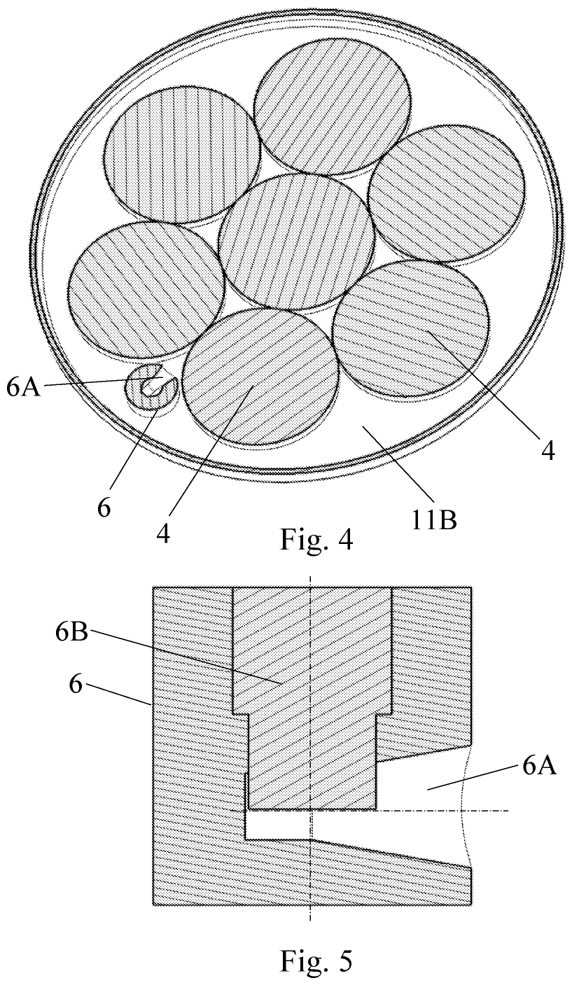

The device further comprises a plurality of gas-generating grains 4 disposed within the base shell 11 of the housing 1 as shown if FIGS. 2 to 4 and 6. The gas-generating grains 4 are disposed in one plane and on an inner surface of a base portion 11B of the base shell 11.

The device further comprises a multi-layer filter 5 disposed between the gas generating grains 4 and the base portion 111B of the cover shell 111 of the housing 1 as shown in FIG. 2. The multi-layer filter 5 comprises at least one layer of steel mesh, at least one layer of steel wool and at least one layer of Si02 felt. The multi-layer filter 5 is illustrated as one piece for the sake of clarity. The multi-layer filter 5 is in a shape of a disc. A sealing ring 10 is disposed around the multi-layer filter 5 so that the sealing ring 10 is between the inner surface of the cover shell 111 and the multi-layer filter 5.

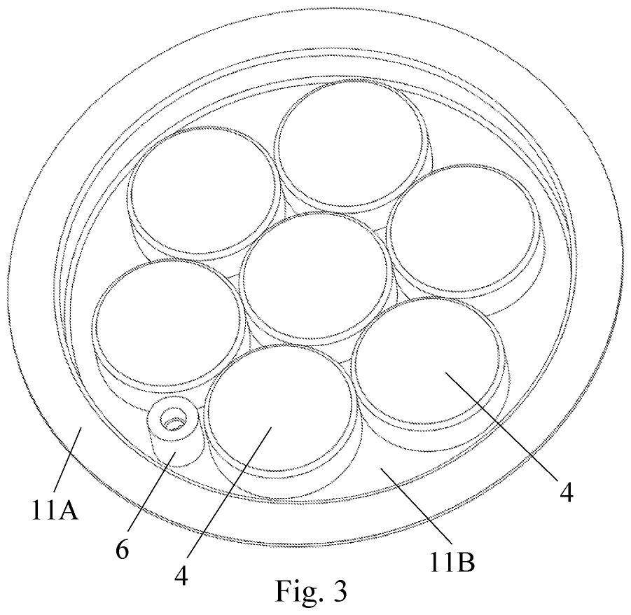

The device further comprises an ignition device 6 associated with the gas generating grains 4 for ignition of said the gas-generating grains 4 as shown in FIGS. 3 to 6. The ignition device 6 comprises an ignitor 6B and an ignition exhaust channel 6A that extends towards the gas-generating grains 4.

The device further comprises a foil section 7 is adhesively attached by means of adhesive 9 to an inner surface of the base portion 111B of the cover shell 111 covering the discharge openings 2 as shown in FIG. 2.

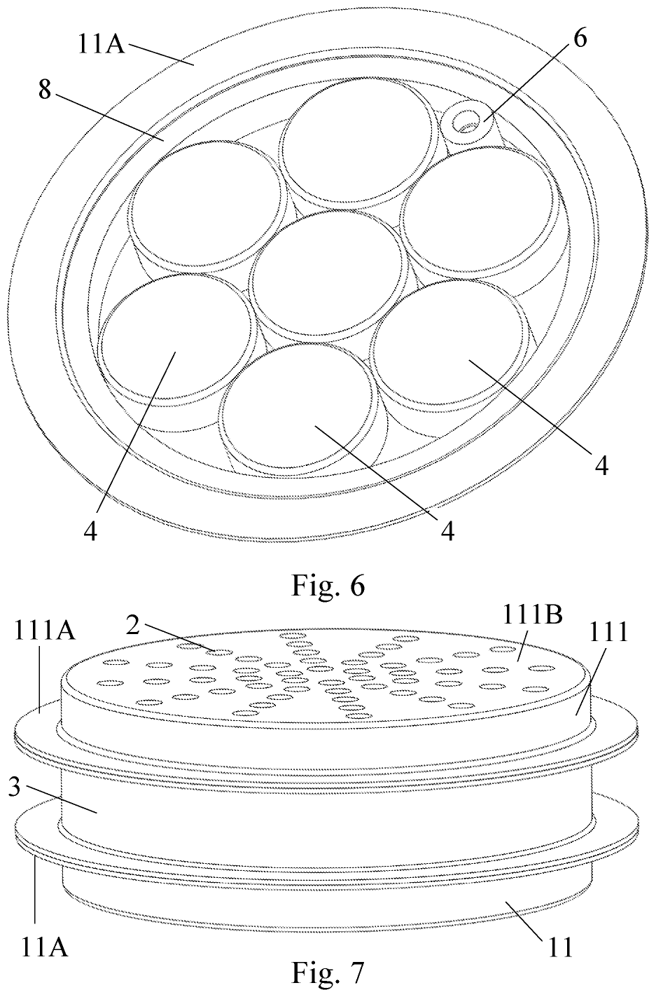

In another embodiment the fire suppressing gas-generating device further comprises a positioning ring 8 arranged around the gas-generating grains 4 and between an inner surface of the base shell 11 and the gas-generating grains 4 for restricting a movement of the gas-generating grains 4 in the housing 1 as shown in FIG. 6.

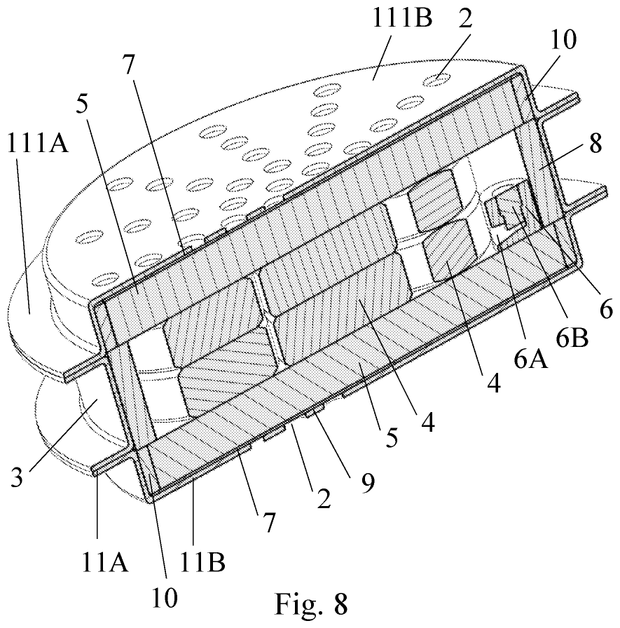

In another embodiment the fire suppressing gas-generating device further comprises a spacer 3 disposed between the base shell 11 and the cover shell 111 and attached to the flanges 11A and 111A of both shells 11 and 111 increasing inner volume of the housing 1 as shown in FIGS. 7 and 8. In the following embodiment both shells 11 and 111 comprises a gas discharge openings 2, a multi-layer filter 5, a foil section 7 and a sealing ring 10. The gas-generating grains 4 are disposed within the spacer 3 and are positioned in said spacer 3 by means of a positioning ring 8. The ignition device 6 is disposed according to the aforementioned principles in order to facilitate effective burning of the gas generating grains 4.

While the invention may be susceptible to various modifications and alternative forms, specific embodiments of which have been shown by way of example in the figures and have been described in detail herein, it should be understood that the invention is not intended to be limited to the particular forms disclosed. Rather, the invention includes all modifications, equivalents, and alternatives falling within the scope of the invention as defined by the following claims.

### LIST OF REFERENCES USED

1—a housing;
2—a discharge opening;
3—a spacer;
4—a gas generating grain;
5—a multi-layer filter;
6—an ignition device;
6A—an exhaust channel;
6B—an ignitor;
7—a foil section;
8—a positioning ring;
9—an adhesive;
10—a sealing ring;
11—a base shell;
11A—a flange of the base shell;
11B—a base portion of the base shell; 111—a cover shell;
111A—a flange of the cover shell; and
111B—a base portion of the cover shell.

1. A fire suppressing gas generating device comprising:
a housing comprising a plate-like base shell and a plate-like cover shell that are connected to each other through flanges of both shells, wherein the cover shell comprises an array of discharge openings distributed generally over the base portion of the cover shell;
a plurality of gas-generating grains disposed within the base shell of the housing;
a multi-layer filter disposed between the gas generating grains and the base portion of the cover shell of the housing;
a sealing ring disposed around the multi-layer filter so that the sealing ring is between the inner surface of the cover shell and the multi-layer filter;
an ignition device associated with the gas generating grains for ignition of said the gas-generating grains;
a foil section attached to the base portion of the cover shell covering the discharge openings.

2. The fire suppressing gas-generating device according to claim 1, characterized in that it further comprises a positioning ring arranged around the gas-generating grains and between an inner surface of the base shell and the gas-generating grains for restricting a movement of the gas-generating grains in the housing.

3. The fire suppressing gas-generating device according to claim 1, characterized in that the foil section is adhesively attached to an inner surface or to an outer surface of the base portion of the cover shell covering the discharge openings.

4. The fire suppressing gas-generating device according to, claim 1, characterized in that the multi-layer filter comprises at least one layer of steel mesh, at least one layer of steel wool and at least one layer of Si02 felt.

5. The fire suppressing gas-generating device according to, claim 4, characterized in that the multi-layer filter is in a shape of a disc.

6. The fire suppressing gas-generating device according to, claim 1, characterized in that for each discharge opening a separate foil section is provided.

7. The fire suppressing gas-generating device according to, claim 1, characterized in that the discharge opening is in a star like shape.

8. The fire suppressing gas-generating device according to, claim 1, characterized in that both shells of the housing are connected by means of laser welding and the welding seam is annular welding seam between the flanges of the both shells of the housing.

9. The fire suppressing gas-generating device according, claim 1, characterized in that the ignition device comprises an ignition exhaust channel that extends towards the gas-generating grains.

10. The fire suppressing gas-generating device according to, claim 1, characterized in that the gas-generating grains are disposed at least in one plane, preferably on an inner surface of a base portion of the base shell.

11. The fire suppressing gas-generating device according to, claim 1, characterized in that it further comprises a spacer disposed between the base shell and the cover shell and attached to the flanges of both shells increasing inner volume of the housing.

12. The fire suppressing gas-generating device according to, claim 1, characterized in that the foil section is selected from the group of the following metals: steel, stainless steel, aluminium, copper and tin.

13. The fire suppressing gas-generating device according to, claim 1, characterized in that the composition of gas-generating grain comprises a guanidine nitrate, basic copper nitrate and a binder.

14. The fire suppressing gas-generating device according to, claim 13, characterized in that the composition of gas-generating grain further comprises a fuel.
